(19) United States
(12) Patent Application Publication
(10) Pub. No.: US 2003/0081248 A1
(43) Pub. Date: May 1, 2003

(54) System and method for print-to-mail notification

(76) Inventor: Shell S. Simpson, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/052,617

(22) Filed: Oct. 25, 2001

(51) Int. Cl. B41J 1/00; G06F 15/00; H04N 1/00

(52) U.S. Cl. 358/1.15; 358/402

(57) ABSTRACT

The present disclosure relates to a system and method for print-to-mail notification. In one arrangement, the system and method pertain to determining that a print-to-mail format document has been printed, identifying attributes of the print-to-mail format document, and generating notification information that identifies that the print-to-mail format document has been printed.

### FIELD OF THE INVENTION

The present disclosure relates to a system and method that facilitates print-to-mail notification. More particularly, the disclosure relates to a system and method with which notifications information can be created that identifies that particular print-to-mail format documents have been generated.

### BACKGROUND OF THE INVENTION

Small to medium sized business offices often generate and send their own bills to their clients. Traditionally, this task entailed printing out bills, manually inserting the bills into envelopes, providing the appropriate postage on the envelopes, and depositing the envelopes with a mail carrier.

Recently, devices have been developed that simplify the above-described process. One such device is the print-to-mail appliance which is adapted to print on relatively heavy weight media, fold the media (e.g., along fold lines provided on the media), and seal the bills (e.g., by heating heat-activated adhesive provided on the media) to form a mailing. In another example, a print-to-mail accessory can be added to a conventional printing device (e.g., printer) to obtain the same functionality.

Although the print-to-mail devices work well for their designated purposes, current systems do not provide identification of which print-to-mail format documents have been generated. Accordingly, where the documents are bills that are to be sent to clients, there presently is no way to track which bills have been generated and mailed beyond having a person manually record this information. This can lead to billing problems. For instance, it can be easy for the user to (e.g., business) send extra copies of the same bill to a client, or not send a bill to the client at all. Clearly, both situations are undesirable and can potentially create problems in terms of client relations.

In view of the aforementioned difficulties, it can be appreciated that it would be desirable to have a print-to-mail system and method that tracks the printing of print-to-mail format documents.

### SUMMARY OF THE INVENTION

The present disclosure relates to a system and method for print-to-mail notification. In one arrangement, the system and method pertain to determining that a print-to-mail format document has been printed, identifying attributes of the print-to-mail format document, and generating notification information that identifies that the print-to-mail format document has been printed.

The present disclosure further relates to a print-to-mail device. In one arrangement, the print-to-mail device comprises a processing device, hard copy generation hardware, and memory including a print-to-mail notifier configured to generate notification information pertinent to printing of a print-to-mail format document.

Other systems, methods, features, and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic representation of an example of the general operation of the invention.

FIG. 2 is an example system in which the invention can be implemented.

FIG. 3 is a schematic of a print-to-mail device shown in FIG. 2.

FIG. 4 is a schematic of a computing device shown in FIG. 2.

FIG. 5 is a flow diagram that provides an overview of the manner in which the system shown in FIG. 2 can be used to generate print-to-mail notification.

FIG. 6 is a flow diagram of operation of a print-to-mail notifier of the print-to-mail device shown in FIG. 3.

### DETAILED DESCRIPTION

Disclosed is a system and method for facilitating print-to-mail notification. To facilitate description of the inventive system and method, example systems are discussed with reference to the figures. Although these systems are described in detail, it will be appreciated that they are provided for purposes of illustration only and that various modifications are feasible without departing from the inventive concept. After the description of the example systems, examples of operation of the systems are provided to explain the manners in which print-to-mail notification can be obtained. Other suitable systems and/or methods are described in U.S. patent application Ser. No. ______, entitled “Print-to-Mail System and Method,” by Shell Simpson and bearing Attorney Docket No. 10007685-1, the disclosure of which is hereby incorporated by reference into the present disclosure.

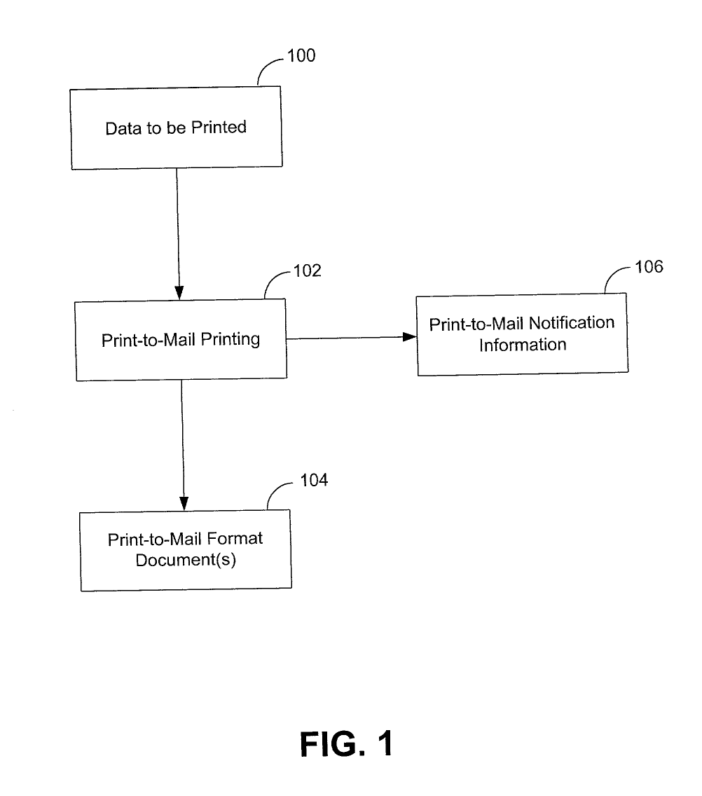

FIG. 1 is a schematic representation of an example of the general operation of the invention. As shown in this figure, data to be printed 100 is delivered to a system or device that facilitates print-to-mail printing 102. In so doing, one or more print-to-mail format documents 104 are generated. In addition, due to the present system and method, print-to-mail notifications information 106 is generated. With this information, users (e.g., businesses) can more easily track which print-to-mail format documents (e.g., bills) have been printed and, presumably mailed to recipients (e.g. customers). The manner in which the notification information 106 is created is described in more detail below with regard to the figures that follow.

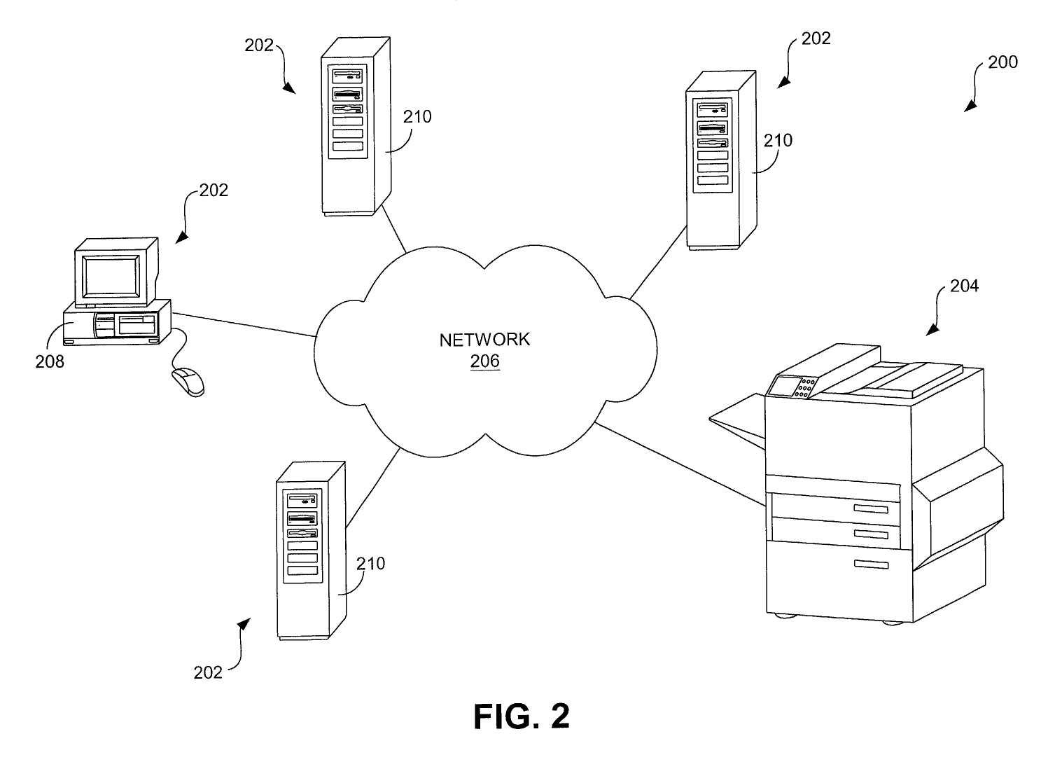

FIG. 2 illustrates an example system 200 with which the invention can be implemented. As indicated in this figure, the example system 200 generally comprises one or more computing devices 202 and a print-to-mail device 204, each of which can be connected to a network 206. As indicated in FIG. 2, the computing devices 202 can be arranged, for example, as one or more personal computers (PCs) 208 and/or one or more network servers 210. More broadly, however, each of the computing devices 202 comprise any device that can be used to communicate via the network 206 and, therefore, access and/or be accessed by services available over the network. By way of example, one or more of the computing devices 202 can, alternatively, comprise a notebook computer, Macintosh computer, handheld computer (e.g., a personal digital assistant or mobile telephone), smart card, etc.

The print-to-mail device 204 comprises any device that is capable of print-to-mail functionality, i.e., that is capable of printing documents in a format designed for direct mailing without the need for an envelope. Although the term “print-to-mail device” is used herein, it is to be understood that the disclosure is not limited to any particular type of device that provides this functionality. Accordingly, the term is intended to include any appliance or printing device (e.g., printer, photocopier, facsimile machine, multifunction peripheral (MFP), etc.) that either inherently provides this functionality or which provides it when a suitable print-to-mail accessory is used in conjunction therewith. An example of a suitable print-to-mail device is a print-to-mail appliance available under the name Print to Mail™ Accessory from the Hewlett-Packard Company.

The network 206 normally comprises one or more sub-networks that are communicatively coupled to each other. By way of example, these networks can include one or more local area networks (LANs) and/or wide area networks (WANs) that comprise a set of networks that forms part of the Internet. In addition to the network connections shown in FIG. 2, one or more of the computing devices 202 can be directly connected to the print-to-mail device 204 (not shown). Direct connection between the computing devices 202 and the print-to-mail device 204 may be likely where the print-to-mail device is used in a home or small office environment in which the user does not have access to a network.

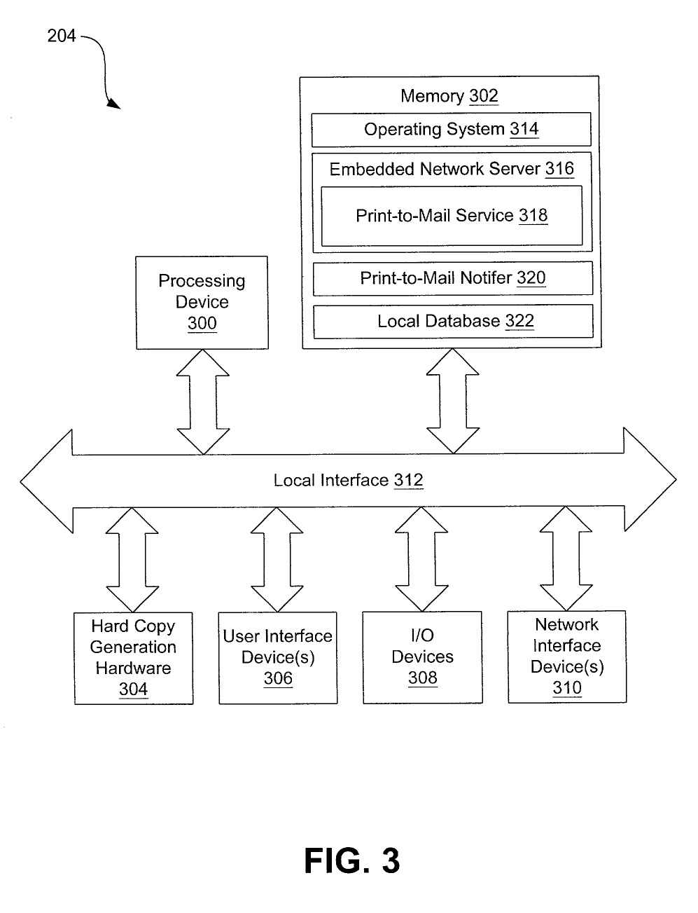

FIG. 3 is a schematic view illustrating an example architecture for the print-to-mail device 204 identified in FIG. 2. As indicated in FIG. 3, the print-to-mail device 204 can generally comprise a processing device 300, memory 302, hard copy generation hardware 304, one or more user interface devices 306, one or more input/output (I/O) devices 308, and one or more network interface devices 310, each of which is connected to a local interface 312 that normally comprises one or more internal and/or external buses.

The processing device 300 is adapted to execute commands stored in memory 302 and can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the print-to-mail device 204. The memory 302 can include any one of a combination of volatile memory elements (e.g., random access memory (RAM, such as DRAM, SRAM, etc.)) and nonvolatile memory elements (e.g., ROM, hard drive, tape, CDROM, etc.).

The hard copy generation hardware 304 comprises the components with which the print-to-mail device 204 can generate hard copy documents and, more particularly, with which the device can generate print-to-mail format documents. For example, the hard copy generation hardware 304 can comprise a print engine that is possible of many different configurations as well as a folding and sealing mechanism that is used to fold the mailing and seal it along one or more of its edges.

The one or more user interface devices 306, where provided, comprise those components with which the user can interact with the print-to-mail device 204. By way of example, the user interface devices 306 comprise one or more function keys and/or buttons with which the operation of the device 204 can be controlled, and a display, such as a liquid crystal display (LCD), with which information can be visually communicated to the user and, where the display comprises a touch-sensitive screen, commands can be entered.

With further reference to FIG. 3, the one or more I/O devices 308 are adapted to facilitate communications of the print-to-mail device 204 with another device and may therefore include one or more serial, parallel, small computer system interface (SCSI), universal serial bus (USB), IEEE 1394 (e.g., Firewire™), and/or personal area network (PAN) components. The network interface devices 310 comprise the various components used to transmit and/or receive data over a network 206. By way of example, the network interface devices 310 include a device that can communicate both inputs and outputs, for instance, a modulator/demodulator (e.g., modem), wireless (e.g., radio frequency (RF)) transceiver, a telephonic interface, a bridge, a router, network card, etc.

The memory 302 typically comprises an operating system 314. In addition, where the print-to-mail device 204 is adapted to support a service that facilitates print-to-mail printing, the memory 302 typically includes an embedded network server 316. The operating system 314 controls the execution of other software and/or firmware and provides scheduling, input-output control, file and data management, memory management, and communication control and related services. The embedded network server 316 comprises software and/or firmware that is used to serve information (e.g., network pages) to browers on the network 206. Where the network 206 comprises the Internet, the embedded network server 316 may function as an embedded web server which serves web pages.

As indicated in FIG. 3, the embedded network server 316, where provided, can comprise a print-to-mail service 318 that, as is discussed in greater detail below, can be accessed as an imaging destination that facilitates the print-to-mail printing process. Although the print-to-mail service 318 has been identified as being supported by the print-to-mail device 204, persons having ordinary skill in the art will appreciate that this service could, alternatively, be provided by another device, for instance one or more of the network servers 210. As will be apparent from the discussions that follow, however, the location of the print-to-mail service 318 is unimportant to the operation of the inventive system and method.

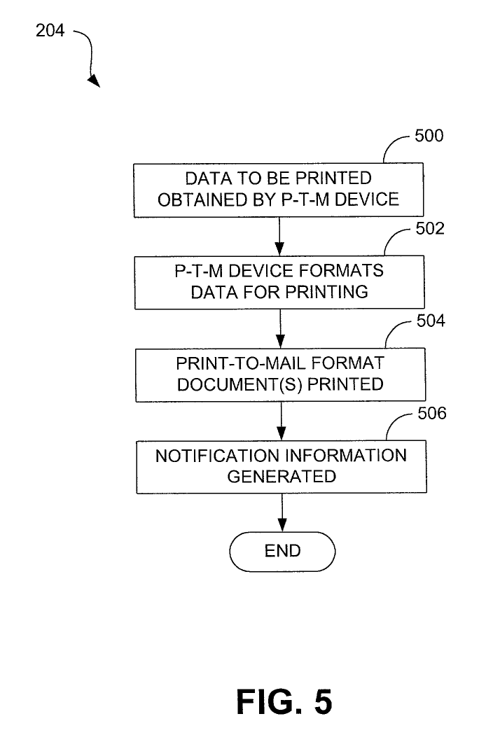

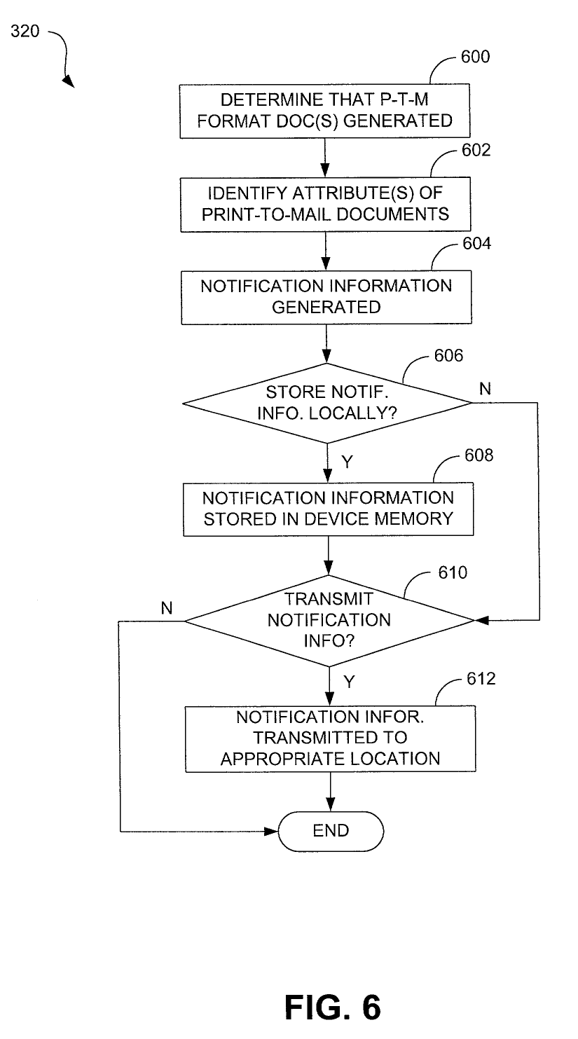

In addition to the components mentioned above, the memory 302 can further include a print-to-mail notifier 320 and a local database 322. The print-to-mail notifier 320 comprises software (firmware) that is configured to generate notification information that identifies that one or more print-to-mail format documents have been generated (i.e., printed) by the print-to-mail service 318. The operation of the print-to-mail notifier 320 is discussed in more detail below with relation to FIGS. 5 and 6. By way of example, the notification information can be stored in the local database 322, if desired.

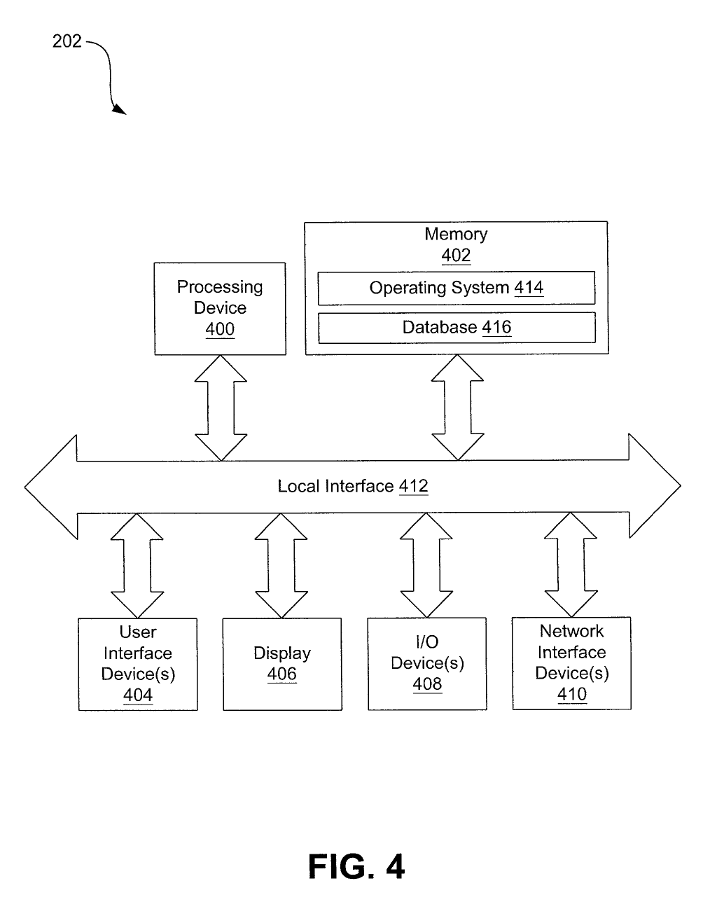

FIG. 4 is a schematic view illustrating an example architecture for one or the computing devices 202 shown in FIG. 2. As indicated in FIG. 4, each computing device 202 can comprise a processing device 400, memory 402, one or more user interface devices 404, a display 406, one or more I/O devices 408, and one or more network interface devices 410, each of which is connected to a local interface 412. The processing device 400 can include any custom made or commercially available processor, a central processing unit (CPU) or an auxiliary processor among several processors associated with the computing device 202, a semiconductor based microprocessor (in the form of a microchip), or a macroprocessor. The memory 402 can include any one of a combination of volatile memory elements (e.g., random access memory (RAM, such as DRAM, SRAM, etc.)) and nonvolatile memory elements (e.g., ROM, hard drive, tape, CDROM, etc.).

The one or more user interface devices 404 comprise those components with which the user can interact with the computing device 202. For example, where the computing device 202 comprises a server, PC, Macintosh, or laptop, these components can comprise a keyboard, mouse, and/or track ball. Where the computing device 202 comprises a handheld device (e.g., PDA, mobile telephone), these components can comprise function keys or buttons, a touch-sensitive screen, a stylus, etc. The display 406 can comprise a computer monitor or plasma screen for a server, PC, Macintosh, or laptop, or a liquid crystal display (LCD) for a handheld device. With further reference to FIG. 4, the one or more I/O devices 408 and the one or more network interface devices 410 can function and can be configured in similar manner to the like-named components identified above with reference to FIG. 3.

The memory 402 normally comprises an operating system 414 and a database 416. The operating system 414 controls the execution of other software and provides scheduling, input-output control, file and data management, memory management, and communication control and related services. As is discussed below, the database 416 can comprise that of a network-based database management system that stores the data used to create the print-to-mail format documents. In any case, however, the database 416 can be used to store notification information identifying that one or more print-to-mail format documents have been generated.

Various software and/or firmware has been described herein. It is to be understood that this software and/or firmware can be stored on any computer-readable medium for use by or in connection with any computer-related system or method. In the context of this document, a computer-readable medium denotes an electronic, magnetic, optical, or other physical device or means that can contain or store a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

An example system having been described above, operation of the system will now be discussed. In the discussions that follow, flow diagrams are provided. It is to be understood that any process steps or blocks in these flow diagrams represent modules, segments, or portions of code that include one or more executable instructions for implementing specific logical functions or steps in the process. It will be appreciated that, although particular example process steps are described, alternative implementations are feasible. Moreover, steps may be executed out of order from that shown or discussed, including substantially concurrently or in reverse order, depending on the functionality involved.

FIG. 5 provides an overview of operation of the print-to-mail device 204, including the provision of notification that one or more print-to-mail format documents have been generated. Beginning with block 500, data to be printed are obtained by the print-to-mail device 204. As will be appreciated by persons having ordinary skill in the art, the data can be obtained in a variety of different ways. For example, in a simple case, a user can have transmitted the data to the print-to-mail device 204 from an appropriate user application executing on the user's computing device (e.g., PC 208).

In another example, the data can have been obtained by the device 204 through use of a network-based print-to-mail service (e.g. print-to-mail service 318) that the user can access with an appropriate browser. In such a scenario, the user can identify the data that are to be printed in the print-to-mail format by, for instance, uploading files from the user's computing device to the print-to-mail service, providing the address of files and/or records that can be retrieved by the service, selecting from various different databases known by the service, manually entering the data that are to be printed, etc.

Irrespective of the manner in which the data are obtained, the print-to-mail device 204 can format the data for printing, as indicated in block 502, and print one or more print-to-mail format documents, as indicated in block 504. At this point, notification information is generated, as indicated in block 506. As is discussed below, the nature of the notification information can vary. Typically, however the notification will at least identify which documents and/or data were printed and when.

FIG. 6 illustrates an example of operation of the print-to-mail notifier 320 of the print-to-mail device 204. As indicated in block 600 of this figure, the print-to-mail notifier 320 first determines that one or more print-to-mail format documents have been generated. This determination can be made actively by the print-to-mail notifier 320 by, for instance, affirmatively detecting this generation, or passively by, for example, receiving a notice from another component of the device 204 (e.g., print-to-mail service 318) that such documents have been printed. In any case, however, the notifier 320 can then identify one or more attributes of the print-to-mail format documents that have been printed, as indicated in block 602, so that various details about the print job can be included in a notification. In some arrangements, the details that will be provided in the notification can be selected by the user. For example, a network-based service (e.g., the print-to-mail service 318) can provide one or more network (e.g., web) pages with which the various desired options can be offered and, if desired, selected. These options can include the date the printing took place, the name of the document that was printed, the identity of the user that initiated the print job, etc. Where the documents are bills that have been generated from various records maintained by or for the user (e.g., business), the details can further or alternatively include the name of the billed customer, one or more billing numbers, the billing period reflected by the print-to-mail format document, etc. Persons having ordinary skill in the art will appreciate that many different pieces of information can be identified by the notifier 320 and, if desired, be included in the notification information made available to authorized users.

Once the various attributes have been identified, notification information is then generated, as indicated in block 604. The nature of the notification information can vary and may depend upon user selections such as those noted above. At this point, it can be determined where notifications are to be provided. This determination can also be dictated by user selections that, for instance, have been registered with an appropriate service (e.g., service 318) configured for this purpose. Accordingly, as indicated in decision element 606, it can be determined whether notification information is to be stored locally within the print-to-mail device 204. If not, flow continues on down to decision element 610 described below. If notification information is to be stored on the device 204, however, flow continues to block 608 at which the information, in the desired format, is stored within device memory 302. Where the print-to-mail device 204 includes a hard disk, this storage can be to the hard disk. If the notification information is to be stored locally, the print-to-mail notifier 220 can organize the information in many different ways. For instance, a separate notification can be provided for each print-to-mail format document that is generated. In another example, the notification information can be grouped by the day on which the documents were generated. In a further example, the notification information can be organized according to some an attribute of the data contained within the print-to-mail format document such as by the intended recipient of the document. In any case, local storage of the notification information will permit authorized users to later review which print-to-mail format documents where generated by browsing to the aforementioned service.

With reference to decision element 610, it further can be determined whether the notification information is to be stored remotely from the print-to-mail device 204. Such remote storage may be particularly desirable where the data used to create the print-to-mail format documents are stored in a database that is accessible via the network 206. For instance, were the data originated from a database supported by a network-based database management system (e.g., Oracle™, Sybase™, etc.), the notification information can be associated with the original data so that the user can see what data (e.g., records) were printed.

To obtain such functionality with the print-to-mail notifier 320, the user typically first configures the notifier such that the notification information will be directed to the proper destination. Again, this configuration can be facilitated with a service (e.g., service 318) accessible over the network 206. In such a case, the user can specify information such as the network address of a database server (e.g., server 210) that maintains the database in which the original data are stored, the name of the database, an identifier for the particular tables and/or records in which the notification information is to be provided, and any other such information that would aid the notifier 320 in delivering a notification to the correct location. By way of example, some or all of this information can be provided to the service by the user entering a structured query language (SQL) statement with the service. In a preferred arrangement, this information can be associated with each print job performed by the print-to-mail device 304 such that the print-to-mail notifier 320 can automatically identify the delivery address for the notification information for each print job received by the device.

Returning to FIG. 6, if the notification information is not to be stored remotely, flow for the session is terminated. If, on the other hand, the notification information is to be stored remotely, flow continues on to block 612 at which the notification information is transmitted to the appropriate location according to the instructions provided by the user in the manner described above.

Operating in the manner described above, the system and method can be used to obtain notifications of what data has been print-to-mail printed and, presumably, mailed. Accordingly, users (e.g., businesses) can more easily track what information has been sent to the intended recipients (e.g., customers).

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for print-to-mail notification, comprising the steps of:
determining that a print-to-mail format document has been printed;
identifying attributes of the print-to-mail format document; and
generating notification information that identifies that the print-to-mail format document has been printed.

2. The method of claim 1, wherein the step of determining that a print-to-mail format document has been printed comprises detecting printing of the print-to-mail document.

3. The method of claim 1, wherein the step of determining that a print-to-mail format document has been printed comprises receiving a notice that a print-to-mail format document has been printed.

4. The method of claim 1, wherein the step of identifying document attributes comprises identifying at least one of a name of the document, a date the document was printed, and a name of a user.

5. The method of claim 1, wherein the step of identifying document attributes comprises identifying at least one of a customer name, a customer number, a billing period to which the document pertains.

6. The method of claim 1, wherein the step of generating notification information comprises generating notification information that identifies at least one of the document attributes.

7. The method of claim 1, further comprising transmitting notification information to a computing device.

8. The method of claim 7, wherein the step of transmitting notification information comprises transmitting notification information to a remote computing device via a network.

9. The method of claim 7, wherein the step of transmitting notification information comprises transmitting the information to a database from which data contained within the print-to-mail format document originated.

10. The method of claim 9, wherein the database is supported by a network-based database management system.

11. The method of claim 1, further comprising storing the notification information within memory of a print-to-mail device that printed the print-to-mail format document.

12. A system for print-to-mail notification, comprising:
means for determining that a print-to-mail format document has been printed;
means for identifying attributes of the print-to-mail format document; and
means for generating notification information that identifies that the print-to-mail format document has been printed.

13. The system of claim 12, wherein the means for identifying document attributes comprise means for identifying at least one of a name of the document, a date the document was printed, and a name of a user.

14. The system of claim 12, wherein the means for identifying document attributes comprise means for identifying at least one of a customer name, a customer number, a billing period to which the document pertains.

15. The system of claim 12, further comprising means for transmitting notification information to a computing device.

16. The system of claim 15, wherein the means for transmitting notification information comprise means for transmitting notification information to a remote computing device via a network.

17. The system of claim 12, further comprising means for storing the notification information within memory of a print-to-mail device that printed the print-to-mail format document.

18. A print-to-mail device, comprising:
a processing device;
hard copy generation hardware; and
memory including a print-to-mail notifier configured to generate notification information pertinent to printing of a print-to-mail format document.

19. The device of claim 18, wherein the hard copy generation hardware comprises a print engine.

20. The device of claim 18, wherein the hard copy generation hardware comprises a folding mechanism and a sealing mechanism.

21. The device of claim 18, wherein the notifier is configured to identify at least one attribute of the print-to-mail format document.

22. The device of claim 18, wherein the memory further comprises a database adapted to store the notification information.

23. The device of claim 18, further comprising a network interface device adapted to transmit notification information to a computing device via a network.

24. The device of claim 18, further comprising an embedded web server that supports a print-to-mail service that is accessible over a network.

25. The device of claim 24, wherein the service comprises a print-to-mail web service that is accessible over the Internet.
